(19) United States
(12) Patent Application Publication
(10) Pub. No.: US 2016/0098413 A1
(43) Pub. Date: Apr. 7, 2016

(54) APPARATUS AND METHOD FOR PERFORMING SNAPSHOTS OF BLOCK-LEVEL STORAGE DEVICES

(71) Applicant: Overland Storage, Inc., San Diego, CA (US)

(72) Inventors: Dale Stephenson, Buford, GA (US); Trevor Heathorn, Palo Alto, CA (US)

(73) Assignee: Overland Storage, Inc.

(21) Appl. No.: 14/505,302

(22) Filed: Oct. 2, 2014

(51) Int. Cl. G06F 17/30

(52) U.S. Cl. CPC G06F 17/30088; G06F 17/30575

(57) ABSTRACT

An improved apparatus and method for performing snapshots of a logical volume within a block-level storage devices is disclosed. When a snapshot is created, the logical volume manager determines the blocks in the relevant volume that are not allocated and lists those blocks in an exception table. Upon receiving a write request, the volume manager checks the exception table to determine whether the specific block in question is unallocated. If it is allocated, the volume manager performs a copy-on-write for the block for the snapshot. If it is unallocated, the volume manager does not copy the block. This results in significant efficiency, since copy-on-write operations will not be performed for unallocated blocks within a snapshot volume.

### FIELD OF THE INVENTION

The present invention relates to an improved apparatus and method for performing snapshots of logical volumes within block-level storage devices.

### BACKGROUND OF THE INVENTION

A substantial amount of the world's digital data is stored on block-level storage devices. An example of a simple block-level storage device is a hard disk drive. An example of a more complicated block-level storage device is a SAN (storage area network) or a software or hardware RAID (redundant array of independent disks).

Block-level storage devices can be managed by logical volume managers, which can create one or more logical volumes containing blocks within the block-level storage device. An example of a logical volume is a device mapper volume in Linux. A file system can then be mounted on a logical volume.

Block-level storage devices can perform read or write operations on blocks of data in response to read or write commands received from another device or layer, such as from a file system.

The prior art also includes the ability to take a snapshot of a logical volume within the block-level storage device. For example, a snapshot of a volume as it exists at time T can be generated and stored. At a later time, the volume can be reconstructed as it existed at time T, even if the contents of the volume has changed since the snapshot was taken.

Examples of prior art systems and methods are shown in FIGS. 1-7. FIGS. 1-7 each depict block-level storage system 100.

In FIG. 1, block-level storage system 100 comprises file system 101, logical volume 102, and block-level device 105. Examples of file system 101 include XFS, Fat16, Fat32, NTFS, ext2, ext3, ext4, reiserFS, JFS, and UFS.

File system 101 manages data in the form of files. Logical volume 102 is a software layer that maps logical storage units to blocks within block-level device 105. File system 101 is stored within logical volume 102. Block-level device 105 is a storage device that writes data and reads data in blocks. Examples of block-level device 105 include a hard disk drive, an optical drive, flash memory, a tape drive, network attached storage (NAS), a storage area network (SAN), a software or hardware RAID, or other storage media.

In FIG. 2, block-level device 105 comprises exemplary blocks 111, 112, 113, 114, 115, 116, 117, and 118. For purposes of illustration, only eight blocks are shown, but it will be understood by one of ordinary skill in the art that block-level device 105 can comprise millions of blocks or more. In this example, volume 102 has been assigned blocks 111, 112, 113, and 114.

In FIG. 3, file system 101 has begun storing files within volume 102, and in this simplified example, blocks 111, 112, and 113 are now used to store data, and block 114 is still free or unallocated. A snapshot is taken of file system 101 and logical volume 102 in their current state to generate snapshot file system 121 and snapshot logical volume 122. The snapshot typically is performed by logical volume manager, such as the device mapper in Linux. Snapshot file system 121 is identical to file system 101 at that point in time. Snapshot logical volume 122 comprises metadata 123, which identifies the logical volume 102 as the basis for the snapshot, which here comprises blocks 111, 112, 113, and 114. Snapshot backing store 125 is used to store a copy of data in blocks that need to be preserved for snapshot logical volume 122. Snapshot backing store 125 typically is its own logical volume within block-level device 105 or another storage device. Metadata 123 can be stored with snapshot backing store 125 or can be stored in the active storage area utilized by a logical volume manager. At this point in time, snapshot backing store 125 is empty. The actual data in blocks 111, 112, 113, and 114 need not be copied or stored as part of snapshot logical volume 122, because the state of logical volume 102 can be recreated later by using metadata 123 and obtaining the actual data from blocks 111, 112, and 113 from block-level device 105 as long as they have not been modified.

In FIG. 4, file system 101 has now modified the data in block 113, which is indicated in FIG. 4 by the label “Block 113′.” Prior to modification of block 113, the logical volume manager copies block 113 into snapshot backing store 125, as block 113 (and not block 113′) is intended to be part of snapshot logical volume 122. This is known as a copy-on-write operation. Metadata 123 lists an identifier for block 113 within its exceptions list, to indicate that block 113 is contained in backing store 124.

In FIG. 4, another snapshot can be taken after block 113 is modified into block 113′. A snapshot is taken of file system 101 and logical volume 102 in their current state to generate snapshot file system 131 and snapshot logical volume 132. The snapshot typically is performed by a logical volume manager, such as the device mapper in Linux. Snapshot file system 131 is identical to file system 101 at that point in time. Snapshot logical volume 132 comprises metadata 133, which identifies the logical volume 102 as the basis for the snapshot, which here comprises blocks 111, 112, 113′, and 114. Snapshot backing store 135 is used to store a copy of data in blocks that need to be preserved for snapshot logical volume 132. Snapshot backing store 135 typically is its own logical volume within block-level device 105 or another storage device. Metadata 133 can be stored with snapshot backing store 135 or can be stored in the active storage area utilized by a logical volume manager. At this point in time, snapshot backing store 135 is empty. The actual data in blocks 111, 112, 113′, and 114 need not be copied or stored as part of snapshot logical volume 132, because the state of logical volume 102 can be recreated later by using metadata 133 and obtaining the actual data from blocks 111, 112, and 113 from block-level device 105 as long as they have not been modified.

In FIG. 5, an alternative approach to FIG. 4 is depicted. When snapshot logical volume 132 is created, metadata 123 for snapshot 121 is modified to refer to snapshot logical volume 132 instead of to blocks in block-level device 105. This can be referred to as a snapshot chaining approach.

In FIG. 6, file system 101 sends a command to write data into block 114, which previously was free or unallocated. Before the writing occurs, block 114 is copied into snapshot backing store 125 and snapshot backing store 135. This is an inefficiency (in terms of time, processing usage, and storage space), since block 114 was free or unallocated and therefore did not contain any user data. However, because the volume manager in the prior art has no knowledge of whether block 114 has been allocated, the copy-on-write occurs as it would with an allocated block. Block 114 is then written, and is represented now as block 114′

In FIG. 7, the same concept shown in FIG. 6 is depicted for a snapshot chaining approach.

What is needed is an improved method and system for performing snapshots for volumes within block-level storage devices, where only data in blocks that are required to restore a volume are copied upon receipt of a write request.

### BRIEF SUMMARY OF THE INVENTION

Described herein is an improved method and system for performing snapshots of a logical volume within a block-level storage device. When a snapshot is created, the logical volume manager determines the blocks in the relevant volume that are not allocated and lists those blocks in the exception table. Upon receiving a write request, the volume manager checks the exception table to determine whether the specific block in question is unallocated.

If it is allocated, the volume manager performs a copy-on-write for the block for the snapshot. If it is unallocated, the volume manager does not copy the block. This results in significant efficiency, since copy-on-write operations will not be performed for unallocated blocks within a snapshot volume.

### BRIEF DESCRIPTION OF THE DRAWINGS

FIG. 1 depicts a prior art block-level storage system.

FIG. 2 depicts a prior art block-level storage system and exemplary blocks of storage.

FIG. 3 depicts a first snapshot taken within a prior art block-level storage system.

FIG. 4 depicts a block being modified, a copy-on-write being performed for the first snapshot, and a second snapshot being taken within a prior art block-level storage system.

FIG. 5 depicts a second snapshot taken within a prior art block-level storage system using a snapshot chaining approach.

FIG. 6 depicts a prior art block-level storage system receiving a block write command for an unallocated block and copy-on-write operations performed for both snapshots.

FIG. 7 depicts a prior art block-level storage system receiving a block write command for an unallocated block and copy-on-write operations performed for both snapshots using a snapshot chaining approach.

FIG. 8 depicts a first snapshot taken within an embodiment of a block-level storage system.

FIG. 9 depicts a block being modified, a copy-on-write being performed for the first snapshot, and a second snapshot being taken within an embodiment of a block-level storage system.

FIG. 10 depicts a second snapshot taken within an embodiment of a block-level storage system using a snapshot chaining approach.

FIG. 11 depicts an embodiment of a block-level storage system receiving a block write command for an unallocated block.

FIG. 12 depicts an embodiment of a block-level storage system receiving a block write command for an unallocated block using a snapshot chaining approach.

FIG. 13 depicts components of an embodiment of a block-level storage system.

### DETAILED DESCRIPTION OF THE INVENTION

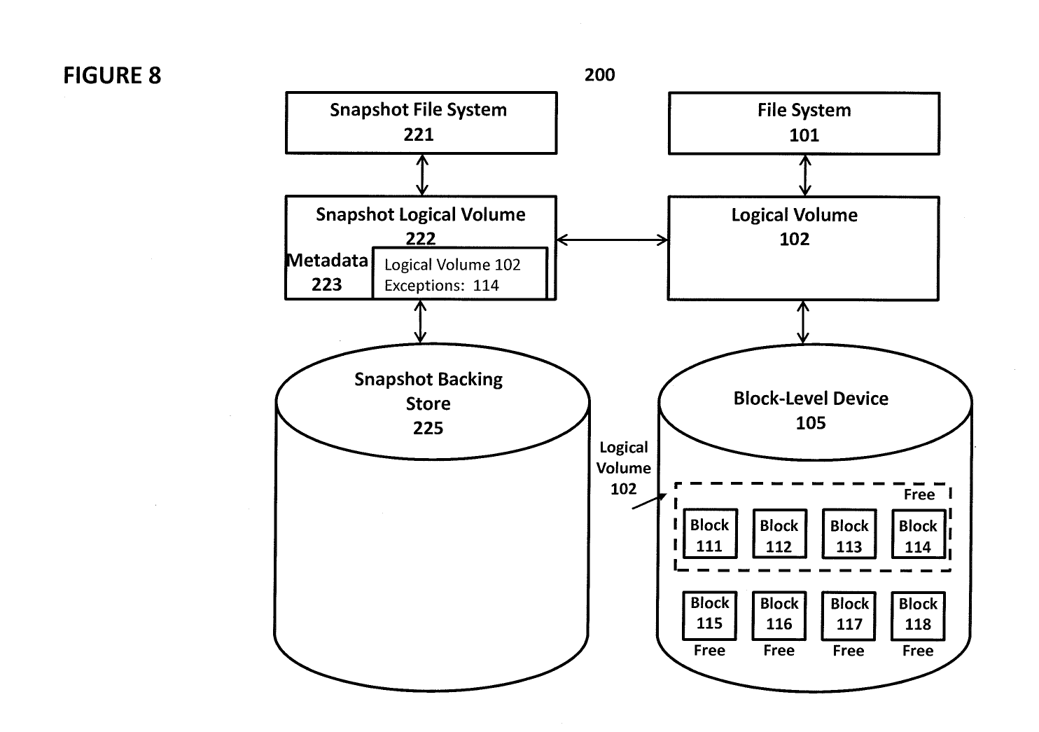

The embodiments are depicted in FIGS. 8-13. FIGS. 8-13 each depict block-level storage system 200. Block-level storage system 200 comprises file system 101, logical volume 102, and block-level device 105 as in the prior art.

In FIG. 8, block-level device 105 comprises exemplary blocks 111, 112, 113, 114, 115, 116, 117, and 118. For purposes of illustration, only eight blocks are shown, but it will be understood by one of ordinary skill in the art that block-level device 105 can comprise millions of blocks or more. In this example, volume 102 has been assigned blocks 111, 112, 113, and 114.

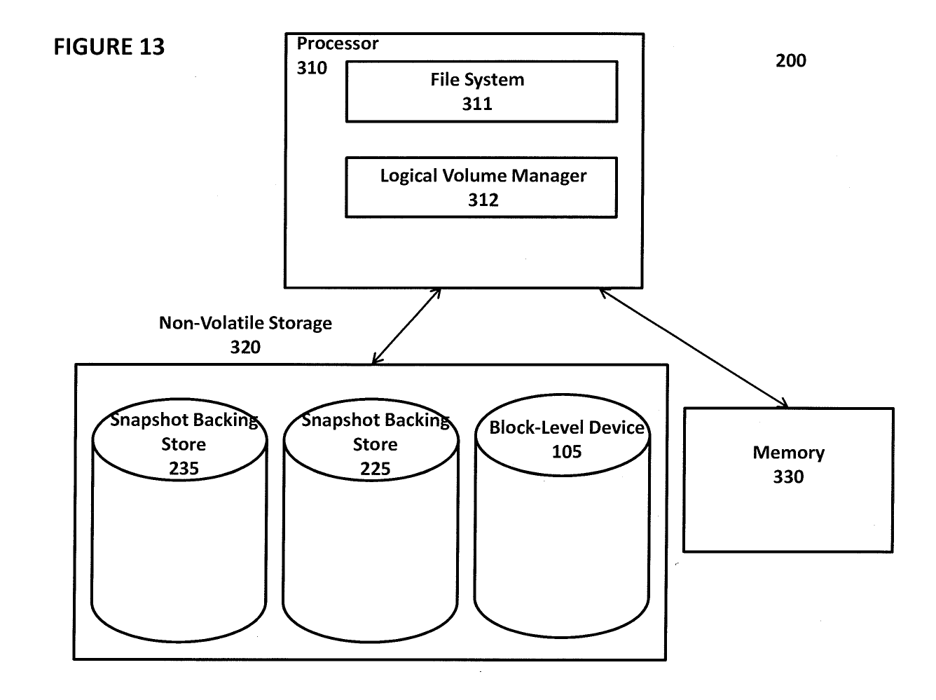

100331 In FIG. 8, file system 101 has begun storing files within volume 102, and in this simplified example, blocks 111, 112, and 113 are now used to store data, and block 114 is still free or unallocated. A snapshot is taken of file system 101 and logical volume 102 in their current state to generate snapshot file system 221 and snapshot logical volume 222. The snapshot typically is performed by logical volume manager 312 (shown in FIG. 13), which can be a modified version of the device mapper in Linux. Snapshot file system 221 is identical to file system 101 at that point in time. Snapshot logical volume 222 comprises metadata 223, which identifies the logical volume 102 as the basis for the snapshot. Snapshot backing store 225 is used to store a copy of data in blocks that need to be preserved for snapshot logical volume 222. Snapshot backing store 225 typically is its own logical volume within block-level device 105 or another storage device. Metadata 223 can be stored with snapshot backing store 225 or can be stored in the active storage area utilized by logical volume manager 312. At this point in time, snapshot backing store 225 is empty. The actual data in blocks 111, 112, 113, and 114 need not be copied or stored as part of snapshot logical volume 222, because the state of logical volume 222 can be recreated later by using metadata 223 and obtaining the actual data from blocks 111, 112, and 113 from block-level device 105 as long as they have not been modified.

Metadata 223 also comprises an exception table. However, unlike in the prior art, logical volume manger 312 comprises lines of code that cause it to analyze file system 221 to determine which blocks, if any, are unallocated or free, and it adds identifiers for those blocks to the exception table. In this example, logical volume manager 312 will determine that block 114 is free and will add block 114 to the exception table within metadata 223.

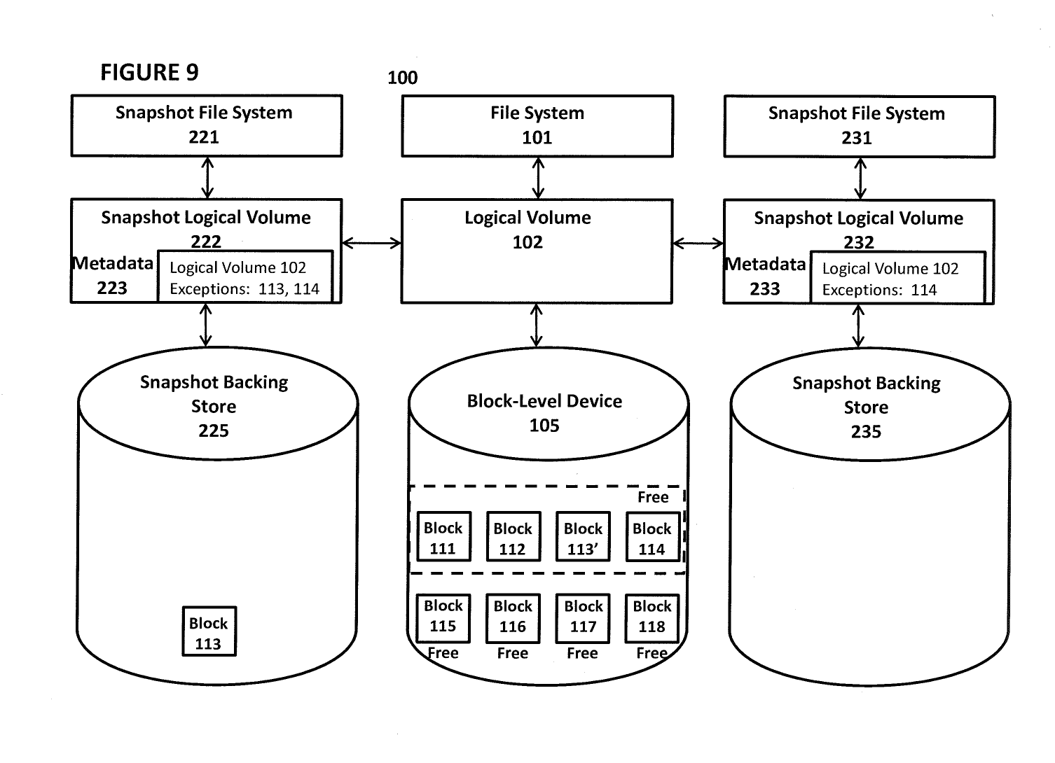

In FIG. 9, file system 101 has now modified the data in block 113, which is indicated in FIG. 9 by the label “Block 113′.” Prior to modification of block 113, logical volume manager 312 checks the exception table in metadata 223 to determine if block 113 is listed (which, at this point in time, it is not), and if it is not listed, logical volume manager 312 copies block 113 into snapshot backing store 225, as block 113 (and not block 113′) is intended to be part of snapshot logical volume 222. At this point, metadata 223 is now revised so that its exception table lists block 113 (as shown in FIG. 9). A copy of block 113 now resides in snapshot backing store 225.

In FIG. 9, snapshot 231 can be taken after block 113 is modified into block 113′. A snapshot is taken of file system 101 and logical volume 102 in their current state to generate snapshot file system 231 and snapshot logical volume 232. The snapshot typically is performed by logical volume manager 312 (shown in FIG. 13), which can be a modified version of the device mapper in Linux. Snapshot file system 231 is identical to file system 101 at that point in time. Snapshot logical volume 232 comprises metadata 233, which identifies the logical volume 102 as the basis for the snapshot. Snapshot backing store 235 is used to store a copy of data in blocks that need to be preserved for snapshot logical volume 232. Snapshot backing store 235 typically is its own logical volume within block-level device 105 or another storage device. Metadata 233 can be stored with snapshot backing store 235 or can be stored in the active storage area utilized by logical volume manager 312.

At this point in time, snapshot backing store 235 is empty. The actual data in blocks 111, 112, 113, and 114 need not be copied or stored as part of snapshot logical volume 232, because the state of logical volume 232 can be recreated later by using metadata 233 and obtaining the actual data from blocks 111, 112, and 113 from block-level device 105 as long as they have not been modified.

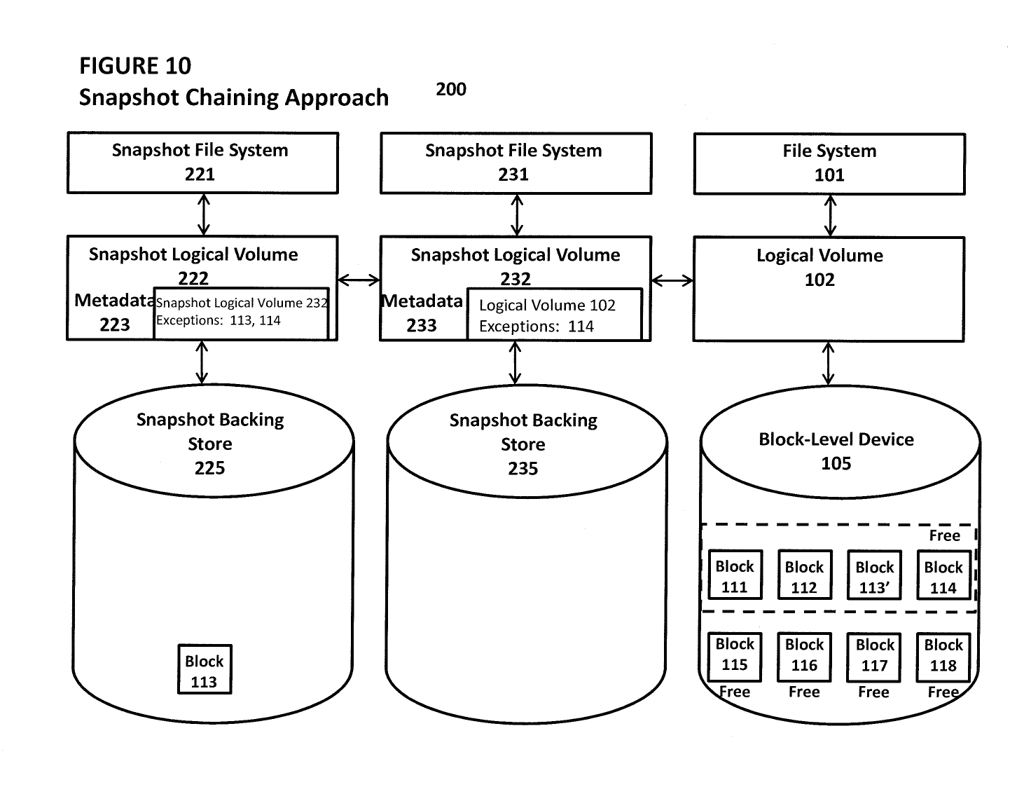

In FIG. 10, an alternative approach to FIG. 9 is depicted using the snapshot chaining approach. When snapshot logical volume 232 is created, metadata 223 for snapshot logical volume 223 is modified to refer to snapshot logical volume 232 instead of to logical volume 102.

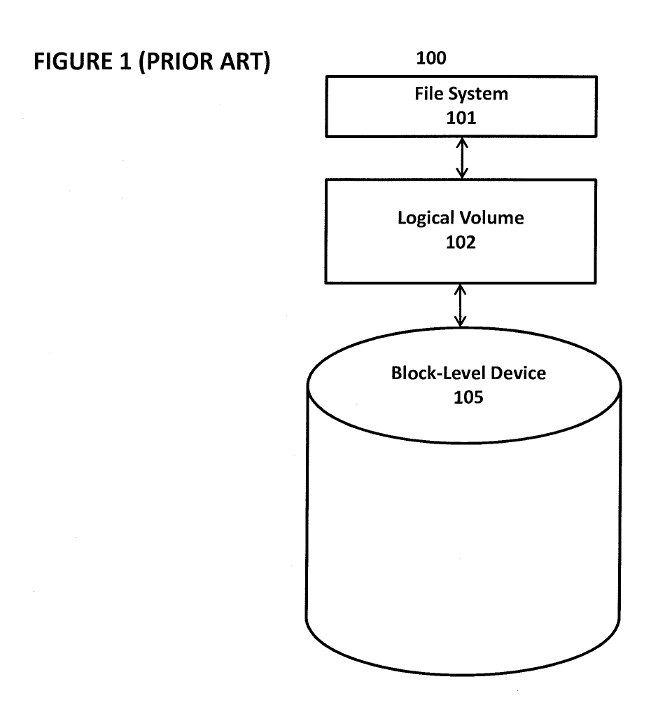

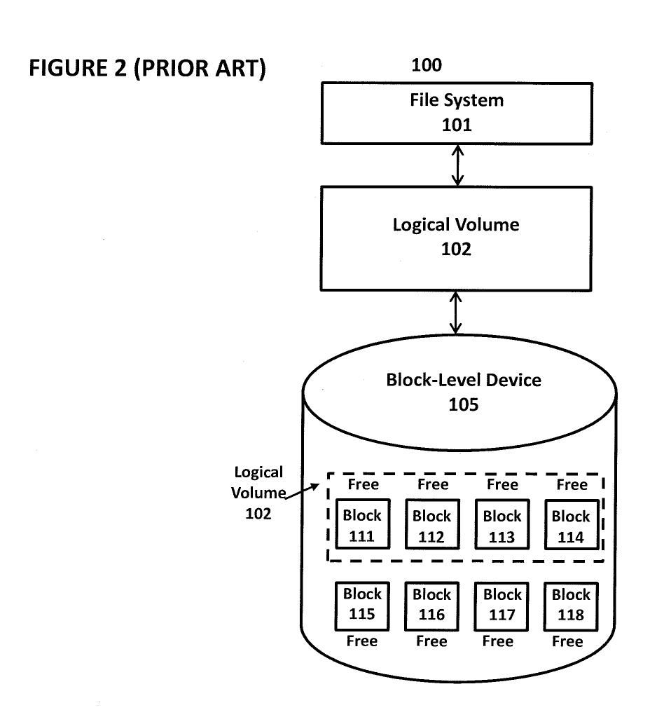

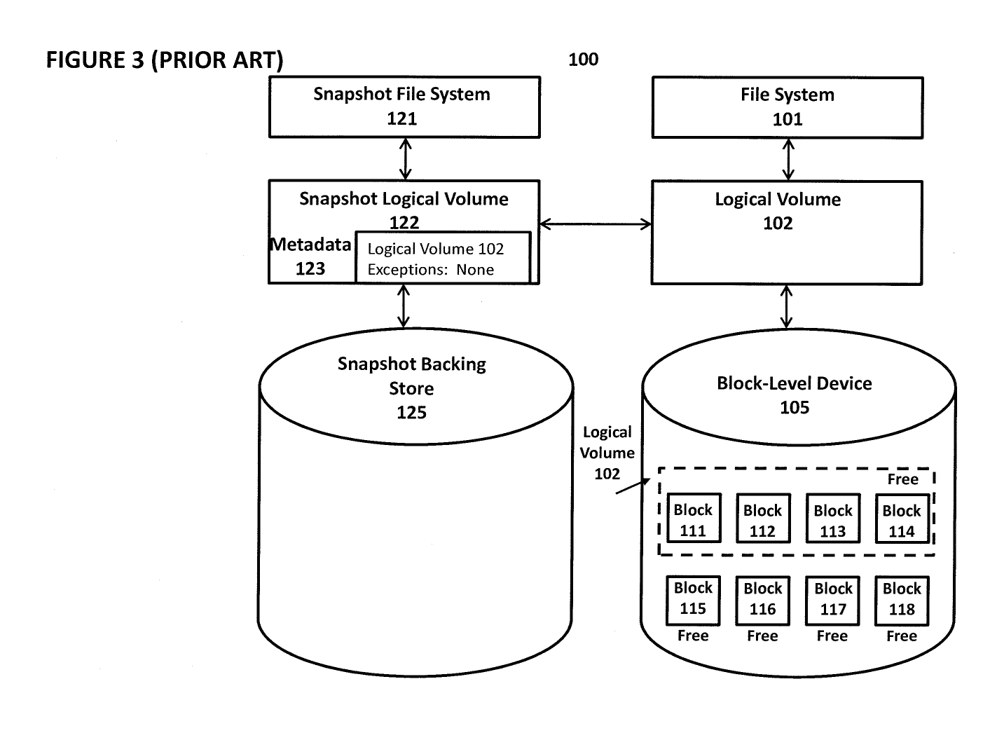

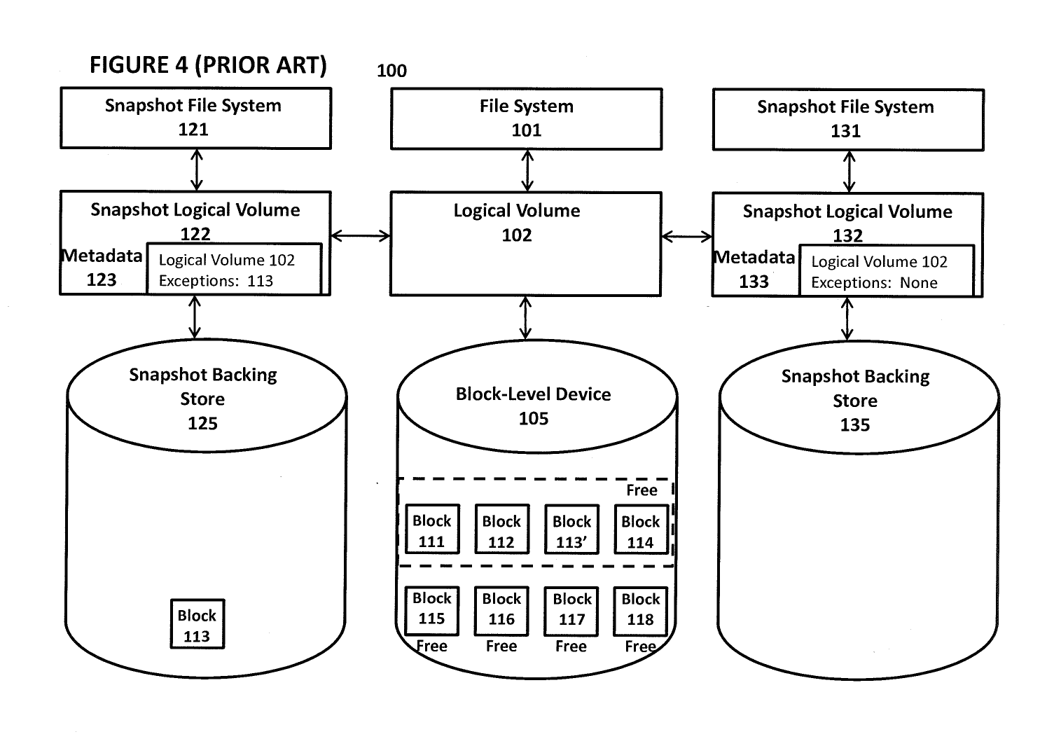

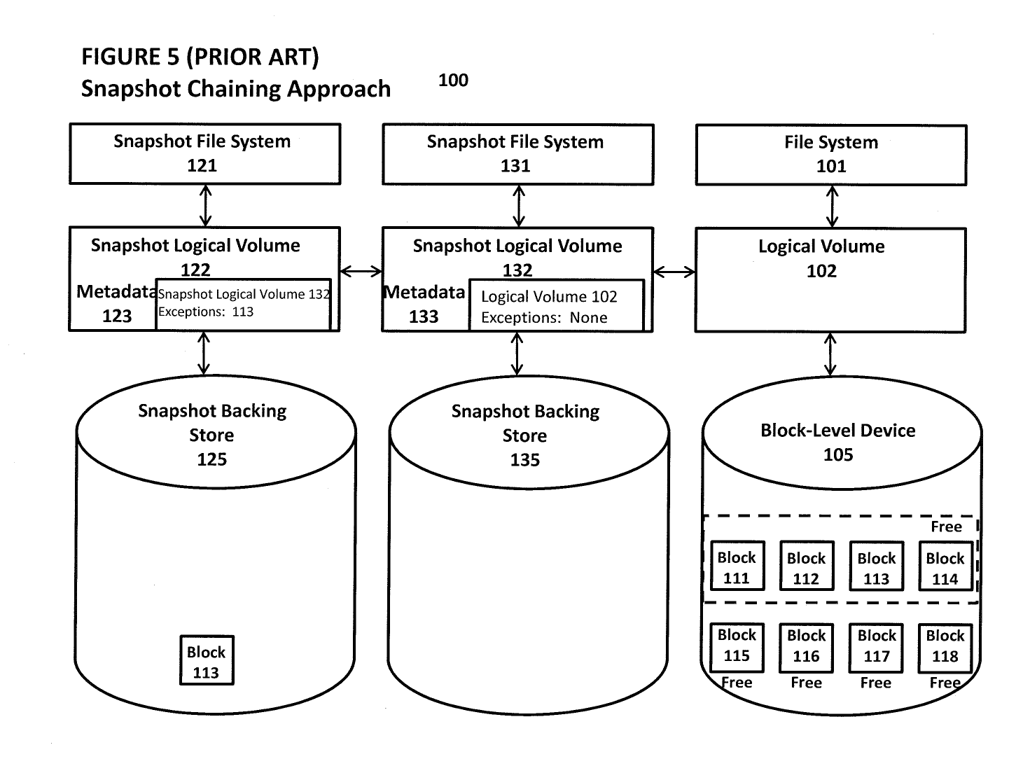

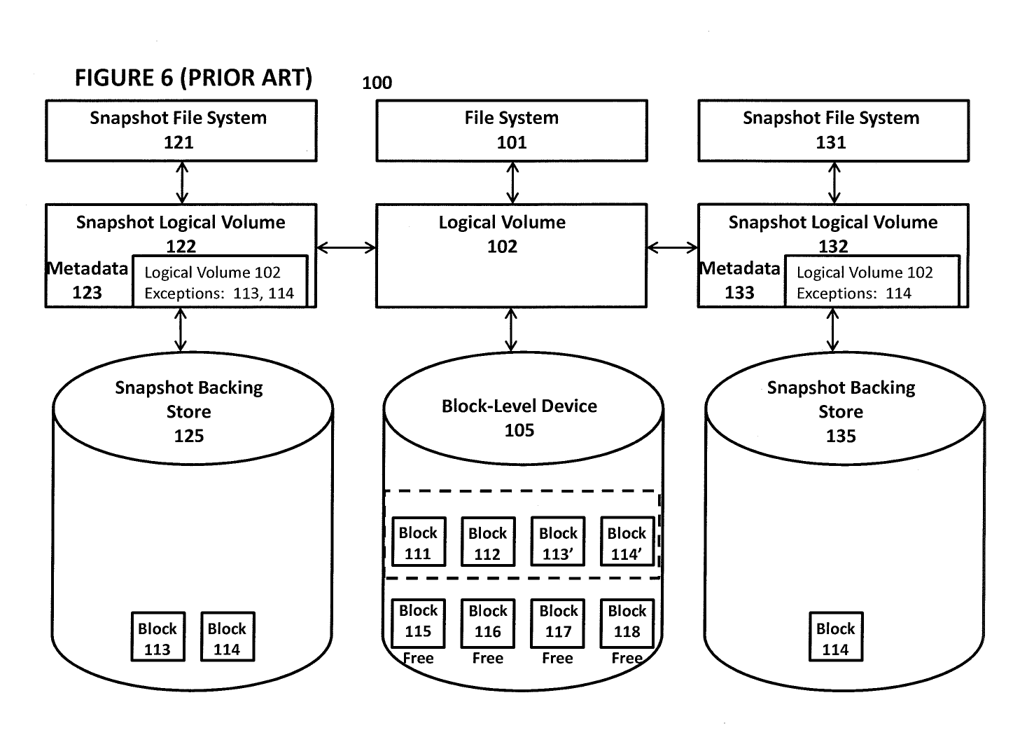

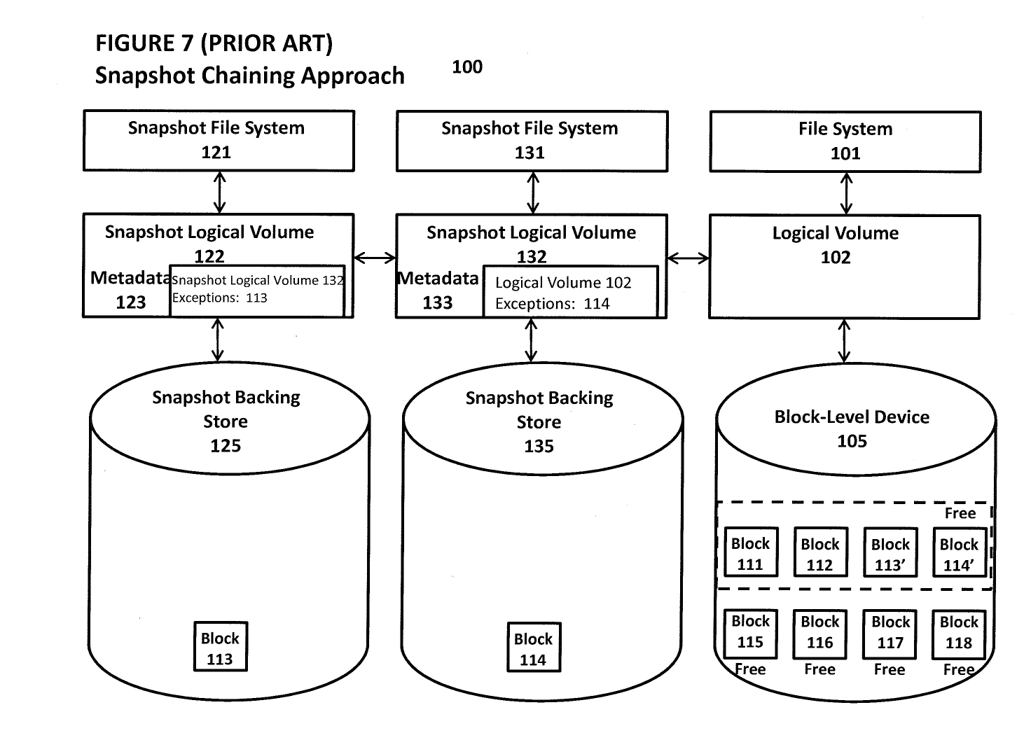

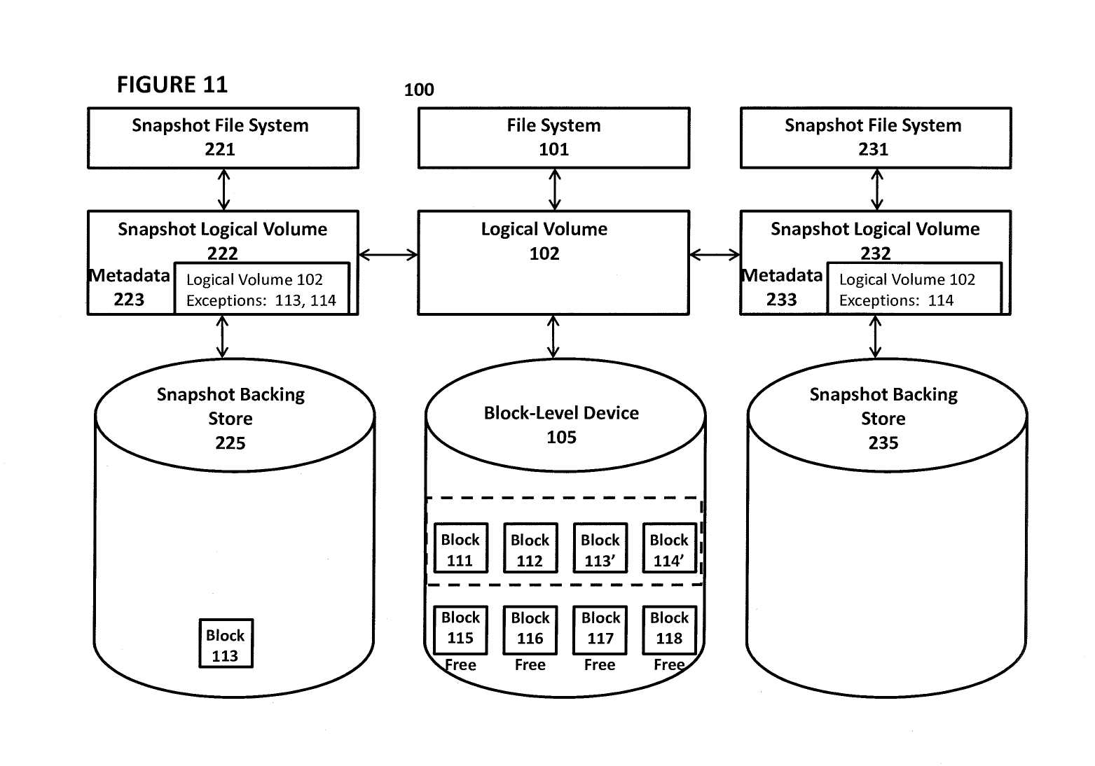

In FIG. 11, file system 101 sends a command to write data into block 114, which previously was free or unallocated. In the prior art systems of FIGS. 1-7, block 114 would be copied at this point into backing store 225 and backing store 235. However, under the embodiment of the invention, exception tables in metadata 223 and 233 list block 114, and the volume manager checks the exception tables and determines that block 114 is not needed by snapshot logical volumes 222 and 232 since block 114 was unallocated at the time those snapshots were created. The volume manager therefore knows not to perform a copy-on-write operation for block 114. Thus, block 114 is not copied into backing store 225 and 235. This is a tremendous efficiency not found in the prior art.

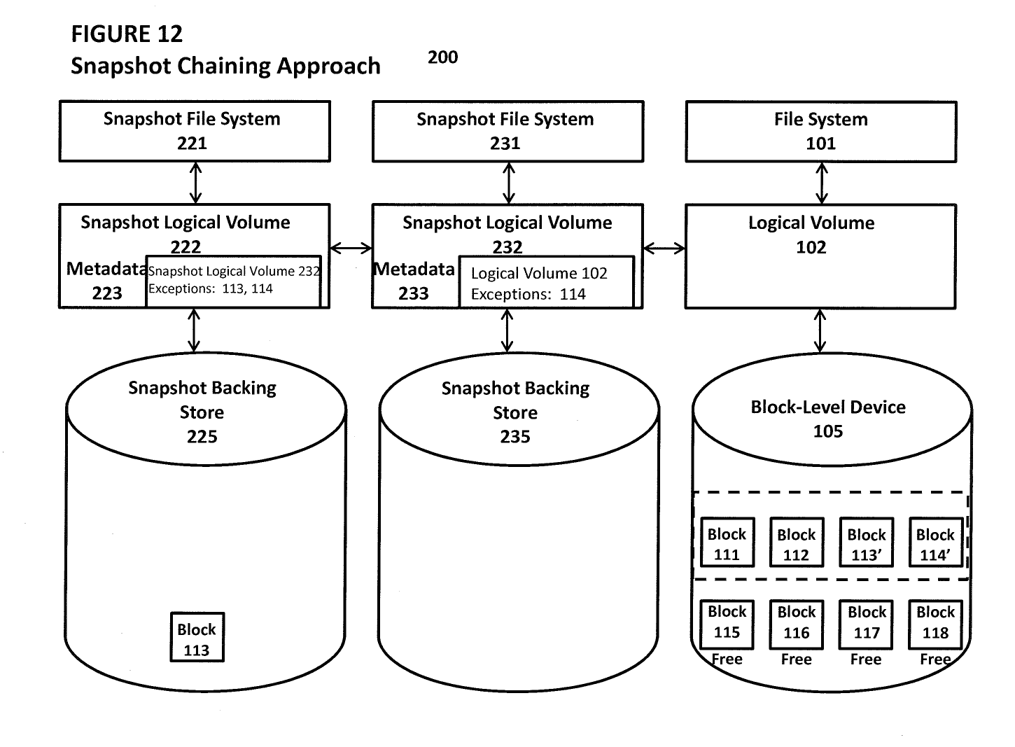

In FIG. 12, the same concept of FIG. 11 is shown but using the snapshot chaining approach. As in FIG. 10, exception tables in metadata 223 and 233 list block 114, and volume manager 312 therefore knows not to perform a copy-on-write operation for block 114. Thus, block 114 is not copied into backing stores 225 and 235.

FIG. 13 depicts components of block-level storage system 200. Block-level storage system 200 comprises processor 310, non-volatile storage 320, and memory 330. Processor 310 can operate file system 311 and logical volume manager 312 and utilizes memory 330. Non-volatile storage 320 comprises block-level device 105 and, optionally, snapshot backing store 225 and snapshot backing store 235 (and any other snapshot backing stores are created in performing snapshots). Examples of non-volatile storage 320 include a hard disk drive, an optical drive, flash memory, a tape drive, network attached storage (NAS), a storage area network (SAN), a software or hardware RAID, or other storage media. If block-level device 105 also is a physical device, then non-volatile storage 320 can be synonymous with block-level device 105.

It is to be understood that the present invention is not limited to the embodiment(s) described above and illustrated herein, but encompasses any and all variations evident from the above description. For example, references to the present invention herein are not intended to limit the scope of any claim or claim term, but instead merely make reference to one or more features that may be eventually covered by one or more claims.

What is claimed is:

1. A storage system, comprising:
a block-level storage device; and
a processor executing:
a file system;
a module for performing a snapshot of volume comprising a plurality of blocks in the block-level storage device and for generating a data structure indicating unallocated blocks within the volume,
wherein the module is configured, upon receiving a command to write to a selected block in the volume, to determine if the selected block is indicated in the data structure and:
to copy the contents of the selected block if the selected block is not indicated in the data structure and to then perform the command, and
to perform the command, without copying the contents of the selected block, if the selected block is indicated in the data structure.

2. The storage system of claim 1, wherein the block-level storage device comprises one or more hard disk drives.

3. The storage system of claim 1, wherein the block-level storage device comprises a storage area network (SAN).

4. The storage system of claim 1, wherein the block-level storage device comprises one or more flash memory arrays.

5. The storage system of claim 1, wherein the module is contained within a logical volume manager.

6. The storage system of claim 1, further comprising a storage device for storing the snapshot.

7. The storage system of claim 6, wherein the snapshot is stored in a logical volume in the storage device.

8. The storage system of claim 1, wherein the file system is an XFS file system.

9. The storage system of claim 1, wherein the file system is an NTFS file system.

10. The storage system of claim 1, wherein the file system is an EXT file system.

11. A method of writing data to a block-level storage device, comprising:
allocating, by a logical volume manager running on a processor, a plurality of blocks in a block-level storage device to a volume;
performing, by a first module running on the processor, a snapshot of the volume;
generating, by the first module, a data structure indicating blocks in the volume that have not been allocated;
receiving, by a second module running on the processor, a command to write to a selected block within the volume;
determining, by the first module, if the selected block is indicated in the data structure; and
if the selected block is not indicated in the data structure, copying the contents of the selected block and executing the command, and
if the selected block is indicated in the data structure, executing the command without copying the contents of the selected block.

12. The method of claim 11, wherein the block-level storage device comprises one or more hard disk drives.

13. The method of claim 11, wherein the block-level storage device comprises a storage area network (SAN).

14. The method of claim 11, wherein the block-level storage device comprises one or more flash memory arrays.

15. The method of claim 11, wherein the first module is contained within the logical volume manager.

16. The method of claim 11, wherein the snapshot is stored on a storage device.

17. The method of claim 16, wherein the snapshot is stored in a logical volume in the storage device.

18. The method of claim 11, wherein the file system is an XFS file system.

19. The method of claim 11, wherein the file system is an NTFS file system.

20. The method of claim 11, wherein the file system is an EXT file system.
